(19) United States
(12) Patent Application Publication
(10) Pub. No.: US 2006/0054188 A1
(43) Pub. Date: Mar. 16, 2006

(54) Plate washing system with ultrasonic cleaning of pipes

(75) Inventors: Robert M. Gifford, Starksboro, VT (US); Lenore Buehrer, Burlington, VT (US); Thomas A. Cleveland, Colchester, VT (US)

Correspondence Address: SUGHRUE MION, PLLC, 2100 PENNSYLVANIA AVENUE, N.W., SUITE 800, WASHINGTON, DC, 20037, US

(73) Assignee: BTI Holding, Inc.

(21) Appl. No.: 10/939,467

(22) Filed: Sep. 14, 2004

(51) Int. Cl. B08B 9/00; B08B 3/00

(52) U.S. Cl. 134/22.1; 134/56 D; 134/58 D; 134/166 C

(57) ABSTRACT

A plate washing system and method of cleaning pipes of the plate washing system. The plate washing system includes at least one manifold having a plurality of pipes configured to be provided within wells of a plate in order to wash the wells, at least one manifold having a plurality of pipes, a tank, an ultrasonic transducer mounted to the tank, and a control system. When tips of the pipes are positioned within the tank, the control system activates the ultrasonic transducer in order to vibrate a fluid within the tank.

### BACKGROUND OF THE INVENTION

1. Technical Field

This invention generally relates to a plate washing system with ultrasonic cleaning of pipes. The ultrasonic cleaning system can provide cleaning of the plate washing system's dispense and aspirate pipes.

2. Discussion of Related Art

Certain laboratory operations, such as immuno assays, require the testing of small samples which are carried out in an arrangement of microwells or wells having volumes of, for example, 50-300 microliters or less formed in microtiter plates, hereinafter referred to generically as well plates. An example of this type of laboratory operation is an enzyme linked immunosorbent assay (“ELISA”) reaction which is performed for measuring the presence or absence of an antigens/antibodycomplex formed within the wells of the well plate.

Reactions of this type involve the adding and removing of liquid reagents within each well. Intentionally, some of the components in the reagent chemically bond to the well. Therefore, at several stages of the reactions, the unbound liquid and components remaining in the wells must be removed and the inside of the wells must be washed by dispensing a wash solution such as water, a buffer solution, or other fluid in the wells using a gravity feed or a pump, and then evacuating the liquid under a vacuum.

The wells can be arranged in a strip or in-line format, or can be arranged in a matrix format. Until recently, commonly used matrices were configured to have 8×12 wells spaced at 9 mm apart between centers, hereinafter referred to as a 96-well plate. However, with the advent of high throughput screening (“HTS”), two more matrixes were introduced which increased the total number of wells while keeping the overall size of the well plate the same: 1) the 384-well plate 3, as shown in FIG. 1, configured to have 16×24 wells 4 spaced at 4.5 mm apart between centers, and 2) the 1536-well plate configured to have 32×48 wells spaced at 2.25 mm apart between centers (not shown). Since the overall foot print of these new well plates are the same as the 96-well plate, the size of the wells in the new microtiter well plates is necessarily smaller than those in the 96-well plates while the depth of the wells remains generally the same. However, this is not always the case.

A conventional washer used for removing the unbound contents in wells of a well plate includes dispense pipes for dispensing the wash solution into the wells of the well plate (e.g., by a pump or gravity feed), and aspirate pipes for evacuating the solution from the wells of the well plate (e.g., by a vacuum or a suction device). In order to quickly wash the well plates, the washing process is performed simultaneously on as many wells of the well plate as possible. A commercial example of such a microplate washer is the Tecan PW384.

As discussed in U.S. Pat. No. 5,951,783 issued to Kontorovich et al., which is herein incorporated by reference, the dispense and aspirate pipes can be provided on a single manifold assembly or separate dispense and aspirate manifolds.

In order to accommodate the well plates having smaller wells, the dispense and aspirate pipes must have small diameters. However, as a result of evaporation, the dispensed materials leave solid materials (such as salts from the assay reagents) within the pipes. The solid material residue can impact the performance of the pipes or even render the pipes inoperable.

Ultrasonic cleaning techniques have been used to remove the residual material from the aspirate and dispense pipes and return the pipes to an operative condition. These ultrasonic cleaning techniques use a commercially available ultrasonic tank of suitable size to allow immersion of the impaired pipe assemblies.

Although the use of ultrasonic cleaning is effective, ultrasonic cleaning using a commercially available tank is a complex process. It requires the addition of cleaning liquid in order to fill the tank, disassembly of the pipe assemblies from the microtiter plate washing system before the pipe assembly is inserted into the tank, and removal of the waste material once the cleaning process has been completed.

### SUMMARY OF THE INVENTION

It is, therefore, desirable to provide a plate washing system having an ultrasonic cleaning system that simplifies the cleaning process.

According to one aspect of the invention, a plate washing system includes at least one manifold having a plurality of pipes configured to be provided within wells of a plate in order to wash the wells; a tank that is capable of being filled with a fluid; an ultrasonic transducer mounted to the tank; and a control system. When the pipes are positioned within the tank, the control system activates the ultrasonic transducer in order to vibrate the fluid within the tank.

According to another aspect of the invention, a method of cleaning pipes of a plate washing system includes providing the washing system, including at least one manifold having a plurality of pipes configured to be provided within wells of a plate in order to wash the wells, a tank, an ultrasonic transducer mounted to the tank, and a control system; moving at least one of manifolds and the tank so that tips of the plurality of pipes are positioned within the tank, filling the tank with a fluid; and activating the ultrasonic transducer in order to vibrate the fluid within the tank. The control system activates the ultrasonic transducer.

### BRIEF DESCRIPTION OF THE DRAWINGS

The advantages, nature and various additional features of the invention will appear more fully upon consideration of the illustrative embodiment of the invention which is schematically set forth in the drawings, in which:

FIG. 1 is a perspective view of a conventional titer plate having 384 wells arranged in a 16×24 matrix;

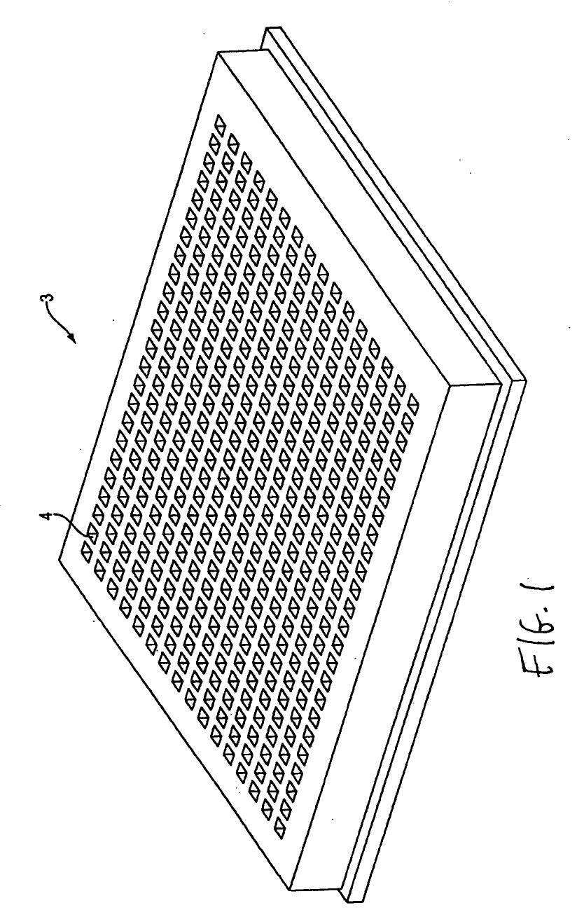

FIG. 2 is a schematic drawing of an embodiment of the system for cleaning a well plate washing system's dispense and aspirate pipes by using ultrasonic vibrations;

FIG. 3 is a schematic of a first embodiment of the well plate washing system;

FIG. 4 is a schematic of a second embodiment of the well plate washing system in which multiple cleaning solutions are used; and

FIG. 5 is a schematic of a third embodiment of the well plate washing system having tank fill and aspirate ports.

### DETAILED DESCRIPTION OF THE DRAWINGS

While the invention is open to various modifications and alternative forms, specific embodiments thereof are shown by way of examples in the drawings and are described herein in detail. There is no intent to limit the invention to the particular forms disclosed.

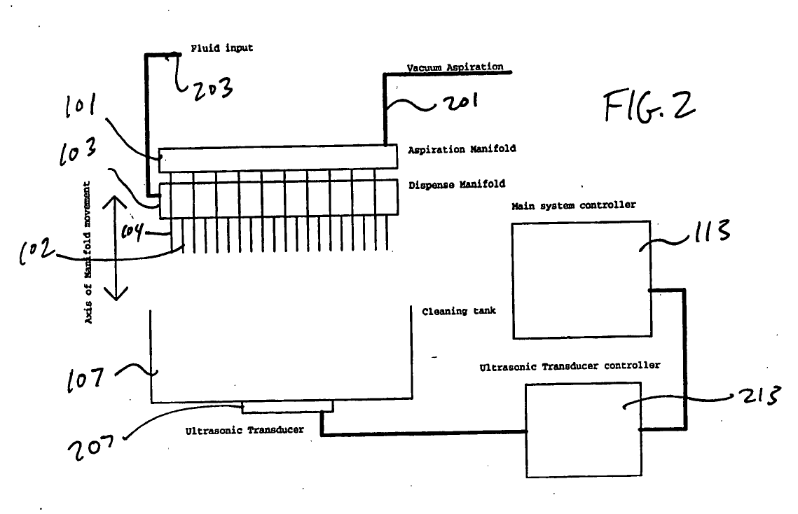

FIG. 2 generally shows a first non-limiting embodiment of an ultrasonic cleaning system of a plate washing system. The ultrasonic cleaning system includes a dispense manifold 103 having dispense pipes 102, an aspiration manifold 101 having aspirate pipes 104, a fluid input line 203, a vacuum aspiration line 201, a cleaning tank 107, and an ultrasonic transducer 207 mounted on the tank 107. However, the invention is not limited to separate dispense and aspiration manifolds and a single manifold containing both aspirate and dispense pipes can also be used.

In order to clean the pipes, the dispense and aspiration manifolds 103, 101 are lowered so that the pipes 102, 104 are within the cleaning tank 107. However, the invention is not limited in this respect. For example, instead the tank 107 could be raised to the level of the pipes 102, 104.

Then, a fluid is introduced into the cleaning tank 107 by the dispense pipes 102 in order to fill the tank 107 with fluid. This fluid can be, for example, a mild detergent or de-ionized water, as is discussed in detail below. However, the invention is not limited by the type of fluid.

The aspiration manifold 103 either draws the fluid from the tank 107 into the aspirate pipes 104 or vents the aspirate pipes 102 to atmospheric pressure. Either way, the aspirate pipes 104 can be filled with the fluid in the tank.

Once the tank 107 and pipes 102, 104 are filled with fluid, the ultrasonic transducer 207 is activated, or energized, causing the fluid in the tank 107 to vibrate. Since the tips of the pipes 102, 104 are submerged in the fluid, the vibration allows the fluid to fill and clean the dispense and aspirate pipes 102, 104. Once the cleaning has taken place, the aspirate pipes 104 are used to evacuate the cleaning tank 107.

A control system, including a main system controller 113 and ultrasonic transducer controller 213, automatically controls the movement of the pipes 102, 104, the dispensing of the fluid into the tank 107, the activation of the ultrasonic transducer 207, and the evacuation of the tank 107. However, the invention is not limited in this respect and additional controllers or a single controller could also be used.

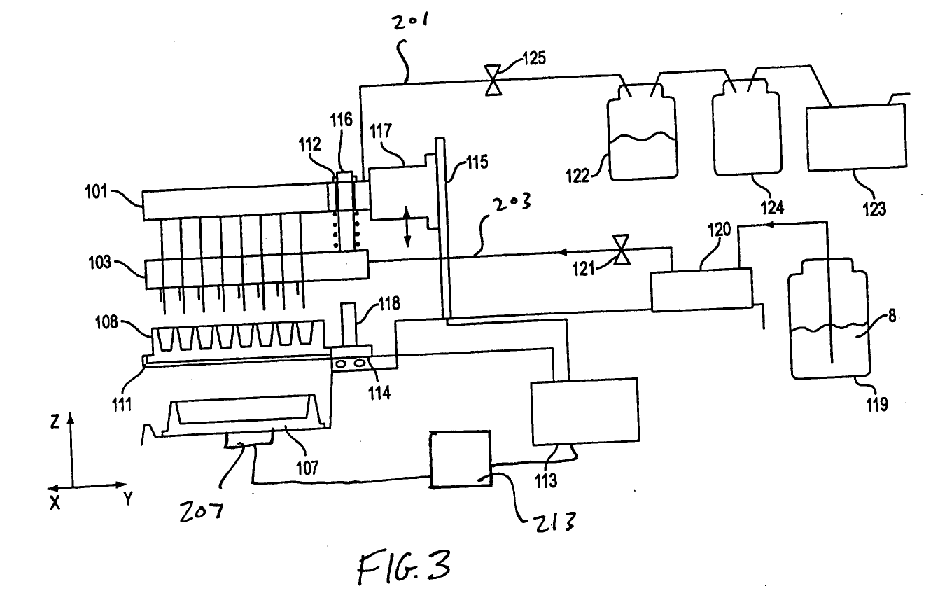

Thus far, the discussion has been directed to the ultrasonic cleaning of the dispensing and aspirate pipes. FIG. 3 shows additional features of a non-limiting embodiment of the overall system for washing a microtiter well plate. In addition, a non-limiting method of cleaning a microtiter well plate, will be described below with respect to the microtiter plate washing system shown in FIG. 3.

A microtiter well plate 108 is positioned on a well plate support mechanism or carrier 111 which in turn is moved into a washing position by the support mechanism positioning system 114 connected to the main system controller 113. However, the invention is not limited by the type of support 111. The support mechanism positioning system is also used to index the support plate in the horizontal X-Y plane relative to the manifolds during a washing operation as required. Alternatively, a drive mechanism for moving the top manifold 101 and bottom manifold 103 in the X-Y plane can be used to achieve the desired relative motion during a wash operation.

In accordance with this embodiment, the bottom manifold 103 is the dispense manifold, which is slaved to the top aspirate manifold 101. However, the invention is not limited in this respect. The aspirate manifold 101 is lowered and raised along the linear guide way 115 along the z-axis by a driving mechanism 117 connected to the main system controller 113. The dispense manifold 103 is suspended from the aspirate manifold 101 by a linear guide 116 and stopped from descending beyond a predetermined position relative to top manifold by a first stop 112. Furthermore, a second stop 118 is provided on the support mechanism 111 for preventing the dispense manifold 103 from entering into the small wells during a wash operation as the aspirate manifold 101 is lowered to evacuate the wells. In order to clean the wells, a wash solution 8 is delivered into the dispense manifold from a source container 119 by means of a pump 120 and a valve 121 through the fluid input line 203. The wash solution 8 is removed from the aspirate manifold 101 through the vacuum aspiration line 201 into a waste container 122 which is separated from a vacuum pump 123 by a trap 124. An opening valve 125 connects the aspirate manifold 101 to the waste container.

When it is desired to clean the aspirate and dispense pipes 102, 104, the support mechanism 111 and second stop 118 are moved out of the way and placed in a home position. The main system controller 113 then lowers the top manifold 101 and bottom manifold 103, allowing their respective pipes to be lowered into the cleaning tank 107. Once the pipes 102, 104 are in position, the dispense pipes 102 provide a fluid to the tank 107, and the pipes 102, 104 are cleaned by the ultrasonic vibrations of the fluid within the tank 107, as is discussed in detail above with respect to FIG. 2.

In the pictured embodiment, the ultrasonic transducer 207 is mounted to the cleaning tank 107 with adhesive. However, the invention is not limited in this respect. For example, the transducer 207 can be mechanically attached to the cleaning tank 107 with a threaded attachment.

The ultrasonic transducer 207 includes a ceramic material that changes dimensions due to the piezoelectric effect when a voltage is applied to the ceramic material. When an alternating voltage at a frequency is applied to the ceramic material, the ceramic material vibrates at that frequency. If the transducer 207 is bonded to the tank 107 filled with liquid, the tank 107 also vibrates and the energy of vibration of the tank 107 can cause small bubbles to form and collapse throughout the liquid. The action of the bubbles collapsing (i.e., cavitation) provides cleaning of the tips of the pipes 102, 104 within the fluid.

In accordance with the first embodiment of the present invention, the main system controller 113 and ultrasonic transducer controller 213 automatically control the cleaning of the ultrasonic transducer 207 in accordance with a pre-programmed cleaning cycle. That is, the controllers 113, 213 can control the times when the pipes 104, 102 are cleaned and can control the duration of soaking of the pipes 104, 102.

For example, the ultrasonic transducer controller 213 or main system controller 113 controls the processes of filling the tank 107, lowing the manifolds 101, 103 (or single manifold), turning on the ultrasonic transducer 207, and evacuating the tank 107. In addition, the controllers 113, 213 can control whether this cleaning cycle is repeated and can control when the cleaning cycles occur.

Furthermore, the controllers 113, 213 can control fluid changes. For example, according to a preferred embodiment of the invention, the pipes 102, 104 are cleaned with a mild detergent and then rinsed with de-ionized water (DiH₂O). First, the pipes are cleaned with the detergent, which reduces the surface tension in the water. This reduced surface tension increases cavitation and, as such, provides more cleaning action. Then, the pipes are rinsed with DiH₂O.

According to the first embodiment, a single source container 119 is used for the well wash solution, detergent, and DiH₂O. Therefore, whenever a change of the fluid within the source is required, the controllers 113, 213 cause a notification to be provided an operator.

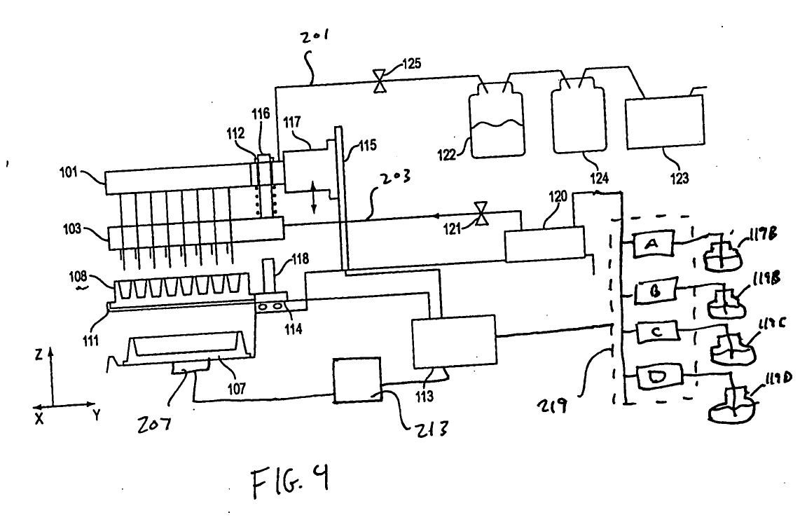

Alternatively, according to a second non-limiting embodiment shown in FIG. 4, an external valve box 219 can be used. This valve box includes valves A-D, which are connected to multiple source containers 219A-D. If multiple source containers are used, then the controllers 113, 213 also control the dispensation of the appropriate fluid (e.g., well wash solution, detergent, or DiH₂O).

In addition, the ultrasonic transducer controller 213 can control the voltage and frequency of the applied ultrasonic voltage. It is preferred that the applied voltage is 100 to 300V with a frequency of 50-60 kHz. For example, according to one design, the ultrasonic controller 213 uses 48 VDC and creates an ultrasonic signal at the transducer of ±300V at 50 kHZ. However, the invention is not limited in this respect.

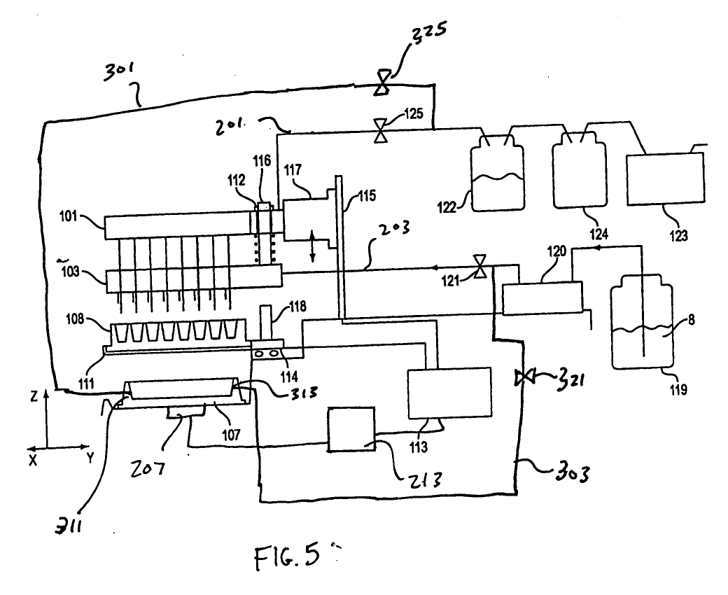

Finally, according to a third non-limiting embodiment shown in FIG. 5, the fluids used for cleaning of the tubes (e.g., detergent and DiH₂O) can be introduced to and evacuated from the tank 107 through ports 313, 311. Dispense and aspirate lines 303, 301, with valves 321, 325, provide the appropriate fluid from the source container (e.g., 119 or one of 119A-D). Again, the controllers 113, 213 can control the dispensation and evacuation of fluid.

It is of course understood that departures can be made from the preferred embodiment of the invention by those of ordinary skill in the art without departing from the spirit and scope of the invention that is limited only by the following claims. For example, the invention is not limited to the specific structures and processed discussed above.

What is claimed is:

1. A plate washing system, comprising:
at least one manifold having a plurality of pipes configured to be provided within wells of a plate in order to wash the wells;
a tank that is capable of being filled with a fluid;
an ultrasonic transducer mounted to the tank; and
a control system, wherein when tips of said plurality of pipes are positioned within the tank, the control system activates the ultrasonic transducer in order to vibrate the fluid within the tank.

2. The system of claim 1, wherein the control system controls movement of at least one of the manifold and the tank in order to position the tips of the pipes within the tank.

3. The system of claim 1, wherein the control system automatically controls movement of at least one of the at least one manifold and the tank so that the plurality of pipes are positioned within the tank, and automatically activates the ultrasonic transducer in order to vibrate the fluid within the tank.

4. The system of claim 3, wherein said plate is a microtiter plate.

5. The system of claim 1, wherein said plurality of pipes includes a plurality of dispense pipes, wherein said control system controls the dispense pipes so that the dispense pipes dispense the fluid within the tank.

6. The system of claim 5, wherein the plurality of pipes further include a plurality of aspirate pipes, wherein the control system controls the aspirate pipes so that the aspirate pipes evacuate the fluid from the tank.

7. The system of claim 1, wherein the control system is programmed to automatically control at least one of fluid changes, soak times, and cleaning times.

8. The system of claim 6, wherein the control system is programmed to control at least one of fluid changes, soak times, and cleaning times.

9. The washing system of claim 1, wherein when the ultrasonic transducer is activated, an a voltage of a predetermined amplitude and frequency is applied to the ultrasonic transducer.

10. The system of claim 9, wherein the applied voltage is 100-300 Volts and has a frequency of 50-60 kHz.

11. The system of claim 6, wherein the control system is programmed to control filling and evacuation of the tank.

12. The system of claim 1, wherein the control system is programmed to automatically control filling and evacuation of the tank.

13. The system of claim 12, wherein said tank includes a fill port and an aspirate port, said fluid being introduced into the tank through the fill port and said fluid being evacuated from the tank through the aspirate port.

14. The method of cleaning pipes of a plate washing system, comprising:
providing the washing system, at least one manifold having a plurality of pipes configured to be provided within wells of a plate in order to wash the wells, a tank, an ultrasonic transducer mounted to the tank, and a control system;
moving at least one of the at least one manifold and the tank so that tips of the plurality of pipes are positioned within the tank, and
filling the tank with a fluid;
activating the ultrasonic transducer in order to vibrate the fluid within the tank;
wherein the control system activates the ultrasonic transducer.

15. The method of claim 14, wherein the control system controls movement of the at least one of the manifold and the tank in order to position the tips of the pipes within the tank.

16. The method of claim 14, wherein the control system automatically controls movement of at least one of the at least one manifold and the tank so that the plurality of pipes are positioned within the tank, and automatically activates the ultrasonic transducer in order to vibrate the fluid within the tank.

17. The method of claim 16, wherein said plate is a microtiter plate.

18. The method of claim 14, wherein said plurality of pipes includes a plurality of dispense pipes, wherein said control system controls the dispense pipes so that the dispense pipes dispense the fluid within the tank.

19. The method of claim 18, wherein the plurality of pipes further include a plurality of aspirate pipes, wherein the control system controls the aspirate pipes so that the aspirate pipes evacuate the fluid from the tank.

20. The method of claim 14, wherein the control system is programmed to automatically control at least one of fluid changes, soak times, and cleaning times.

21. The method of claim 19, wherein the control system is programmed to control at least one of fluid changes, soak times, and cleaning times.

22. The method of claim 14, wherein when the ultrasonic transducer is activated, an a voltage of a predetermined amplitude and frequency is applied to the ultrasonic transducer.

23. The method of claim 22, wherein the applied voltage is 100-300 Volts and has a frequency of 50-60 kHz.

24. The method of claim 19, wherein the control system is programmed to control filling and evacuation of the tank.

25. The method of claim 14, wherein the control system is programmed to automatically control filling and evacuation of the tank.

26. The method of claim 25, wherein said tank includes a fill port and an aspirate port, said fluid being introduced into the tank through the fill port and said fluid being evacuated from the tank through the aspirate port.
